(19) United States
(12) Patent Application Publication
(10) Pub. No.: US 2009/0224107 A1
(43) Pub. Date: Sep. 10, 2009

(54) Reduced Span Wings with Wing Tip Devices, and Associated Systems and Methods

(75) Inventor: James Douglas McLean, Seattle, WA (US)

Correspondence Address: PERKINS COIE LLP (BOEING), P.O. BOX 1247, PATENT - SEA, SEATTLE, WA, 98111-1247, US

(73) Assignee: The Boeing Company, Chicago, IL (US)

(21) Appl. No.: 12/042,174

(22) Filed: Mar. 4, 2008

(51) Int. Cl. B64C 23/06

(52) U.S. Cl. 244/199.4

(57) ABSTRACT

Reduced span wings with wing tip devices, and associated systems and methods are disclosed. A method for designing a wing in accordance with a particular embodiment includes establishing a target lift value for a winglet to be attached to a wing, the wing having a wing root, a wing tip and a twist distribution that results in a loading at the wing tip that is higher than a target loading level. The method can further include selecting a planform shape of the winglet to produce less of an increase in loading at the wing tip compared to the wing tip loading produced by other winglet planform shapes having the same target lift value. Accordingly, in particular embodiments, the winglet design can offset or at least partially offset the reduced wing tip loading produced by the twist distribution.

### TECHNICAL FIELD

The following disclosure relates generally to reduced span wings with wing tip devices, and associated systems and methods.

### BACKGROUND

The idea of using winglets to reduce induced drag on aircraft wings was studied by Richard Whitcomb of NASA and others in the 1970s. Since then, a number of variations on this idea have been patented (see, for example, U.S. Pat. No. 4,205,810 to Ishimitsu and U.S. Pat. No. 5,275,358 to Goldhammer, et al.). In addition, a number of tip device variations are currently in service. Such devices include horizontal span extensions and aft-swept span extensions canted upward or downward at various angles. These devices can be added to a new wing during the initial design phase of an all-new aircraft, or they can be added to an existing wing as a retrofit or during development of a derivative model.

The induced drag of a wing or a wing/winglet combination can be calculated with reasonable accuracy using the classic “Trefftz plane theory.” According to this theory, the induced drag of an aircraft wing depends only on the trailing edge trace of the “lifting system” (i.e., the wing plus tip device), as viewed directly from the front or rear of the wing, and the “spanload.” The spanload is the distribution of aerodynamic load perpendicular to the trailing edge trace of the wing. Aerodynamicists often refer to this aerodynamic load distribution as “lift,” even though the load is not vertical when the trailing edge trace is tilted from horizontal. Adding a winglet or other wing tip device to a wing changes both the trailing edge trace (i.e., the “Trefftz-plane geometry”) and the spanload. As a result, adding such a device also changes the induced drag on the wing.

For a given Trefftz-plane geometry and a given total vertical lift, there is generally one spanload that gives the lowest possible induced drag. This is the “ideal spanload,” and the induced drag that results from the ideal spanload is the “ideal induced drag.” For a flat wing where the Trefftz-plane geometry is a horizontal line, the ideal spanload is elliptical. Conventional aircraft wings without winglets are close enough to being flat in the Trefftz-plane that their ideal spanloads are very close to elliptical. For conventional aircraft wings having vertical or near-vertical winglets (i.e., nonplanar lifting systems), the ideal spanload is generally not elliptical, but the ideal spanload can be easily calculated from conventional wing theory.

Conventional aircraft wings are generally not designed with ideal or elliptical spanloads. Instead, they are designed with compromised “triangular” spanloads that reduce structural bending loads on the wing. Such designs trade a slight increase in induced drag for a reduction in airframe weight. The degree of compromise varies considerably from one aircraft model to another. To produce such a triangular spanload, the wing tip is typically twisted to produce “washout.” Washout refers to a wing that twists in an outbound direction so that the trailing edge moves upward relative to the leading edge. Washing out the wing tip in this manner lowers the angle of attack of the wing tip with respect to the wing root, thereby reducing the lift distribution toward the wing tip.

Designing a new wing and developing the associated tooling for a new wing is an expensive undertaking. Accordingly, some aircraft manufacturers develop derivative wing designs that are based at least in part on an initial design. While such designs can be less expensive to develop, they typically include at least some performance compromises. Accordingly, there remains a need for improved, cost-effective wing development processes.

### SUMMARY

The present disclosure is directed generally to reduced span wings with wing tip devices, and associated systems and methods. A method for designing a wing in accordance with a particular embodiment includes establishing a target lift value for a winglet to be attached to a wing, with the wing having a wing root, a wing tip, and a twist distribution that results in a loading at the wing tip that is less than a target loading level. For example, the twist distribution can result in a washout at the wing tip that is less than a target washout level, resulting in a loading at the wing tip that is above a target loading level. The method further includes selecting a planform shape of the winglet to produce less of an increase in loading at the wing tip compared to the wing tip loading produced by other winglet planform shapes having the same target lift value. For example, in a further particular embodiment, selecting a planform shape includes selecting a planform shape that produces a minimal loading increase at the wing tip when compared with all other planform shapes having the same target lift value.

Another aspect of the disclosure is directed to an arrangement of wings for aircraft of different sizes, and includes a first wing having a first wing span, a first twist distribution, a first root, a first tip, and a target location between the first root and the first tip. The arrangement further includes a second wing corresponding in part to the first wing and having a second root and a second tip. The second wing further includes a second twist distribution between the second root and the second tip that is generally identical to the first twist distribution between the first root and the target location. The second wing further includes a winglet at the second tip.

In a further particular aspect of the foregoing arrangement, the winglet is the second of two winglets. The first wing has a first winglet, with a sweep angle of the second winglet relative to the second wing greater in an aft direction than is a sweep angle of the first winglet relative to the first wing.

Still a further aspect of the disclosure is directed to a method for manufacturing an arrangement of wings, and includes using a wing-forming tool to manufacture a first wing having a first root, a first tip, a target location between the first root and the first tip, a first span, and a first spanwise twist distribution. The method further includes using the same wing-forming tool to manufacture a second wing having a second root, a second tip, a second span less than the first span, and a second spanwise twist distribution between the second root and the second tip that is generally identical to the first spanwise twist distribution between the first root and the target location. The method further includes connecting a winglet to the second wing at the second tip. In further particular embodiments, using the wing-forming tool can include laying up a composite structure over a first spanwise portion of the tool for the first wing, and laying up a composite structure over a second spanwise portion of the tool, less than the first spanwise portion of the tool, for the second wing.

### BRIEF DESCRIPTION OF THE DRAWINGS

FIG. 1 is a partially schematic, isometric illustration of an aircraft having wings and wing tip devices configured in accordance with an embodiment of the disclosure.

FIG. 2 is a partially exploded, detailed illustration of a wing and winglet shown in FIG. 1.

FIG. 3A is a plan view of a wing and corresponding winglet in accordance with an embodiment of the disclosure.

FIG. 3B is a graph illustrating twist angle/washout as a function of span for a wing and a baseline wing in accordance with an embodiment of the disclosure.

FIGS. 4A-4B are flow diagrams illustrating methods for designing wings in accordance with embodiments of the disclosure.

FIG. 5 is a graph illustrating span load as a function of span for a variety of wings in accordance with an embodiment of the disclosure.

FIG. 6 is a plan view of a wing and an unfolded winglet in accordance with an embodiment of the disclosure.

FIGS. 7A-7B illustrate representative chord-wise locations for winglets in accordance with embodiments of the disclosure.

FIG. 8 illustrates several cant orientations for winglets in accordance with embodiments of the disclosure.

FIG. 9 is a flow diagram illustrating a method for manufacturing a wing in accordance with an embodiment of the disclosure.

FIGS. 10A-10B illustrate tools for manufacturing wings in accordance with an embodiment of the disclosure.

### DETAILED DESCRIPTION

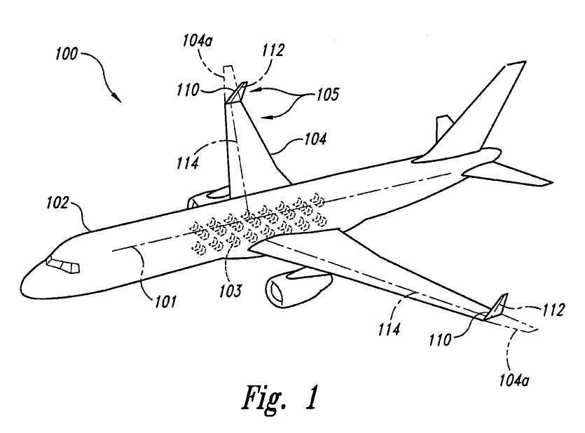

The following disclosure describes reduced span wings with wing tip devices, and associated systems, arrangements and methods. Certain specific details are set forth in the following description and in FIGS. 1-10B to provide a thorough understanding of various embodiments of the invention. Other details describing well-known structures and systems often associated with aircraft and aircraft wings are not set forth in the following description to avoid unnecessarily obscuring the description of the various embodiments of the invention.

Many of the details, dimensions, angles, and other specifications shown in the Figures are merely illustrative of particular embodiments. Accordingly, other embodiments can have other details, dimensions, and specifications without departing from the present disclosure. In addition, other embodiments may be practiced without several of the details described below.

FIG. 1 is a top isometric view of an aircraft 100 having a wing/winglet combination 105 configured in accordance with an embodiment of the disclosure. In one aspect of this embodiment, the aircraft 100 includes an airfoil such as a wing 104 extending outwardly from a fuselage 102. The fuselage 102 can be aligned along a longitudinal axis 101 and can include a passenger compartment 103 configured to carry a plurality of passengers (not shown). In one embodiment, the passenger compartment 103 can be configured to carry at least 50 passengers. In another embodiment, the passenger compartment 103 can be configured to carry at least 150 passengers. In further embodiments, the passenger compartment 103 can be configured to carry other numbers of passengers. In still other embodiments (such as military embodiments), the passenger compartment 103 can be omitted or can be configured to carry cargo.

In a particular embodiment, the wing 104 can have a span that is reduced when compared to the span of a baseline wing 104a, which is shown schematically in dashed lines in FIG. 1. The wing 104 can be based to a large degree on the baseline wing 104a and can accordingly have several characteristics in common with the baseline wing 104a, as will be discussed in further detail later. As will also be discussed in further detail later, winglets 110 can be added to the wing 104 and can be particularly selected and/or configured to offset potential performance inefficiencies resulting from the differences between the wing 104 and the baseline wing 104a upon which it is based.

In some cases, the baseline wing 104a includes a baseline winglet, and in other cases, the baseline wing 104a has no winglet. In either case, the winglets 110 provided for the wing 104 can be sized, shaped and installed in a manner that accounts for the reduced span of the wing 104. For example, in one embodiment, the winglets 110 can be retrofitted to the wing 104 to reduce the impact on wing lift and/or drag caused by reducing the wing span. In another embodiment, the winglets 110 can be incorporated into the design of a new derivative aircraft that utilizes an existing wing configuration. In either case, the design of the winglet 110 can improve the efficiency of an aircraft having a reduced-span wing 104, without requiring the entire wing to be re-designed.

Although the winglet 110 of the illustrated embodiment is combined with a wing, in other embodiments, the winglet 110 can be combined with other types of airfoils to reduce aerodynamic drag and/or serve other purposes. For example, in one other embodiment, the winglet 110 can be combined with an aft-mounted horizontal stabilizer. In another embodiment, the winglet 110 can be combined with a forward-wing or canard to reduce the aerodynamic drag on the canard. In further embodiments, the winglet 110 can be combined with other airfoils. Furthermore, throughout this disclosure and the following claims, the term “winglet” shall refer generally to a wing tip device configured in accordance with this disclosure. In particular embodiments, the winglets can be vertical. In other embodiments, the winglets can be canted from the vertical, and in still further embodiments, the winglets can include horizontal span extensions. As will be described later, embodiments in which the winglets are vertical or at least canted up (or down) from horizontal can be particularly useful for reducing space occupied by the aircraft 100 at an airport gate.

In a further aspect of an embodiment shown in FIG. 1, the wing 104 has a wing quarter-chord line 114 that is swept at least generally aft relative to the longitudinal axis 101, and the winglet 110 has a winglet quarter-chord line 112 that is swept further aft relative to the wing quarter-chord line 114. As described in greater detail below, sweeping the winglet quarter-chord line 112 aft in this manner can favorably change the spanload on the combination of the wing 104 and the winglet 110 to provide an increased drag reduction when compared with the wing 104 without the winglet 110, and/or when compared with a winglet 110 that is not properly configured.

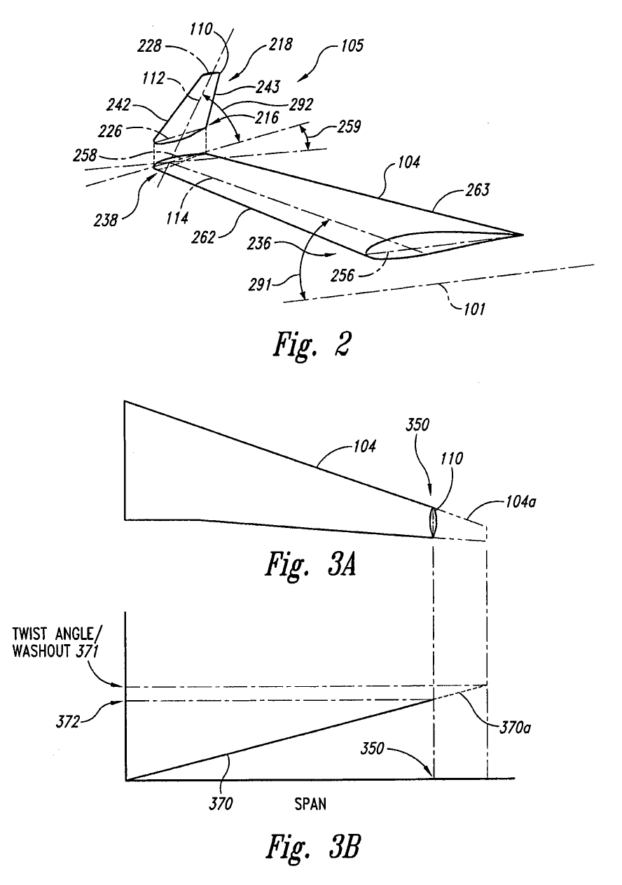

FIG. 2 is an enlarged exploded isometric view of the wing/winglet combination 105 of FIG. 1, configured in accordance with an embodiment of the disclosure. In one aspect of this embodiment, the wing 104 includes a wing tip portion 238 and a wing root portion 236. The wing root portion 236 can be configured to be fixedly attached to the fuselage 102 (FIG. 1) and can define a wing root chord 256. The wing tip portion 238 can define a wing tip chord 258 offset laterally from the wing root chord 256 along the wing quarter-chord line 114. The wing tip chord 258 can have a washout twist (e.g., a downward twist) relative to the wing root chord 256, as illustrated by the twist angle 259. Such washout twist is provided to reduce the lift distribution toward the wing tip and in turn reduce the bending load on the wing. Reducing the bending load on the wing can favorably reduce the structural weight of the wing 104, albeit at the expense of a slight drag increase.

In another aspect of this embodiment, the winglet 110 includes a winglet tip portion 218 and a winglet root portion 216. The winglet root portion 216 can be configured to be fixedly attached to the wing tip portion 238 of the wing 104 and can define a winglet root chord 226. The winglet tip portion 218 can similarly define a winglet tip chord 228 offset from the winglet root chord 226 along the winglet quarter-chord line 112. In a further aspect of this embodiment described in greater detail below, the winglet quarter-chord line 112 is swept aft relative to the wing quarter-chord line 114 to favorably change the spanload on the wing 104 and in turn reduce the induced drag on the wing 104.

In yet another aspect of this embodiment, the wing 104 includes a wing leading edge portion 262 and a wing trailing edge portion 263. Similarly, the winglet 110 can include a winglet leading edge portion 242 and a winglet trailing edge portion 243. In the illustrated embodiment, the winglet 110 is a full-chord winglet with the winglet leading edge portion 242 positioned at least proximate to the wing leading edge portion 262, and the winglet trailing edge portion 243 positioned at least proximate to the wing trailing edge portion 263. In other embodiments described in greater detail later, partial-chord winglets configured in accordance with other embodiments of the disclosure can be fixedly attached to the wing 104 such that the winglet leading edge portion 242 and/or the winglet trailing edge portion 243 are/is offset from the corresponding wing leading edge portion 262 and/or the wing trailing edge portion 263, respectively.

In a further aspect of this embodiment, the wing 104 can have a generally trapezoidal planform with an aspect ratio of about 10 and a taper ratio of about 0.25. In other embodiments, the wing 104 can have other aspect ratios and other taper ratios. For example, in one other embodiment, the wing 104 can have an aspect ratio greater than 10 and/or a taper ratio greater than 0.25. In another embodiment, the wing 104 can have an aspect ratio less than 10 and/or a taper ratio less than 0.25. In a further aspect of this embodiment, the wing quarter-chord line 114 can be swept aft at an angle 291 of about 35 degrees with respect to the longitudinal axis 101. In other embodiments, the wing quarter-chord line 114 can be positioned at other angles relative to the longitudinal axis 101. For example, in one other embodiment, the wing 104 can be at least generally unswept. In yet another embodiment, the wing 104 can be swept forward.

In the illustrated embodiment of FIG. 2, the winglet 110 can have a length of about 15% of the semi-span of the wing 104 and a taper ratio of about 0.50. In addition, in this embodiment, the winglet quarter-chord line 112 can be swept aft at an angle 292 of about 35 degrees with respect to the wing tip chord 258. In other embodiments, the winglet 110 can have other lengths, other taper ratios, and other sweep angles. For example, in one other embodiment, the winglet 110 can have a length of about 10% of the semi-span of the wing 104, a taper ratio of about 0.40, and an aft sweep angle of about 25 degrees with respect to the wing tip chord 258.

FIG. 3A is plan view illustration of the wing 104 and the baseline wing 104a shown in FIG. 1, along with the winglet 110 configured in accordance with an embodiment of the disclosure. As shown in FIG. 3A, the wing 104 can have a shorter span than the baseline wing 104a, but can share other aspects with the baseline wing 104a. For example, in a particular embodiment, the wing 104 and the baseline wing 104a can have generally the same planform shape, up to a target location 350. The span of the wing 104 may be less than the span of the baseline wing 104a to allow the wing to be used with a smaller aircraft fuselage 101 (FIG. 1) and allow the aircraft to occupy less space at an airport gate. In a particular embodiment, the twist angle or washout of the wing 104 can be the same as that of the baseline wing 104a, up to the target location 350, as is shown in FIG. 3B. FIG. 3B is a graph illustrating the twist angle or washout of the wings as a function of span. Line 370 indicates that the twist angle distribution for both the wing 104 and the baseline wing 104a are the same up to the target location 350. Outboard of the target location 350, line 370a indicates the twist angle distribution of the baseline wing 104a continuing outward in a spanwise direction. For purposes of illustration, the twist angle distribution is shown as a linear function of span in FIG. 3B. In other embodiments, the twist angle distribution may be non-linear and/or non-monotonic.

As is also shown in FIG. 3B, the baseline wing 104a has a target twist or washout level 371 at its outboard-most location, while the wing 104 has a resulting twist or washout level 372 at its outboard-most location that is less than the target twist level 371. Because the resulting twist or washout level 372 is less than the target twist or washout level 371, the wing 104 may have performance aspects that are less than optimal and/or otherwise amenable to improvement. By selectively configuring the winglet 110, some or all of the performance loss resulting from using a wing 104 having a twist angle distribution sized for a larger span wing (e.g., the baseline wing 104a) can be regained. In particular, because the resulting twist level 372 of the wing 104 is less than the target twist level 371, the wing tip of the wing 104 may be more heavily loaded than the target loading level. The characteristics of the winglet 110 can be selected to produce less of an increase in the loading at the wing tip when compared to a conventional winglet, in order to compensate for this effect.

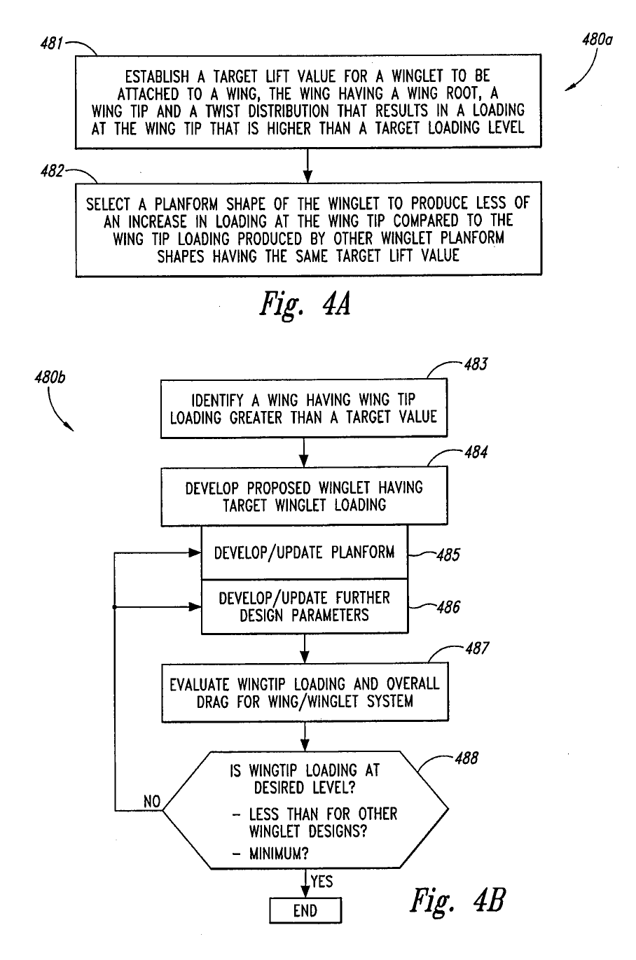

FIG. 4A is a flow diagram illustrating a process 480a for designing a wing in accordance with a particular embodiment of the disclosure. The process 480 can include establishing a target lift value for a winglet that is to be attached to a wing (process portion 481). The target lift value can be selected based on the degree to which the designer wishes the winglet to reduce wing tip loading when compared to the loading produced by a conventional winglet. The wing includes a wing root, a wing tip, and twist distribution that results in a loading at the wing tip that is higher than a target loading level. For example, as discussed above with reference to FIGS. 3A and 3B, the twist of the wing at the wing tip may be less than optimal, resulting in higher loading at the wing tip. Process portion 482 includes selecting a planform shape of the winglet to produce less of an increase in the loading at the wing tip compared to the wing tip loading produced by other winglet planform shapes having a same target lift value. For example, process portion 482 can include a direct calculation to identify an optimum or at least improved planform shape that produces less of an increase in wing loading at the wing tip, when compared to conventional winglets. In other embodiments, process portion 482 can include an iterative process at which an initial planform shape is selected and evaluated (e.g., using conventional aerodynamic calculation tools), and then adjusted until an optimum or at least improved wing tip loading results. In either of these embodiments, the planform shape of the winglet refers generally to the shape of the winglet projected onto a plane generally parallel to the major surfaces of the winglet.

FIG. 4B illustrates a more detailed process 480b for carrying out an embodiment of the method described above with reference to FIG. 4A. Some or all of the processes shown in FIGS. 4A and 4B may be carried out automatically, e.g., by instructions contained in a computer-readable medium and executed by a computer or other automated device. As shown in FIG. 4B, the process 480b can include identifying a wing having a wing tip loading greater than a target value (process portion 483). In process portion 484, the process includes developing a proposed winglet having a target winglet loading. This can include developing a planform shape (e.g., a wetted area, leading edge sweep angle, trailing edge sweep angle, etc.), as shown in process portion 485, and developing further design parameters (e.g., toe-in angle, cant angle, chord wise location, etc.), as is shown in process portion 486. Process portion 487 includes evaluating wing tip loading and overall drag for the wing/winglet system. In process portion 488, the wing tip loading is compared to a desired loading level. The desired level can be a level less than for other winglet designs developed during an iterative process, and/or it can be a minimum level based on a variety of other winglet designs. For example, the desired level can correspond to a minimal loading increase at the wingtip when compared with all other planform shapes having the same target lift value. In either embodiment, if the wing tip loading is at the desired level, the process ends. If not, then the planform shape and/or further design parameters are updated (via process portions 485 and/or 486) and the updated design is evaluated.

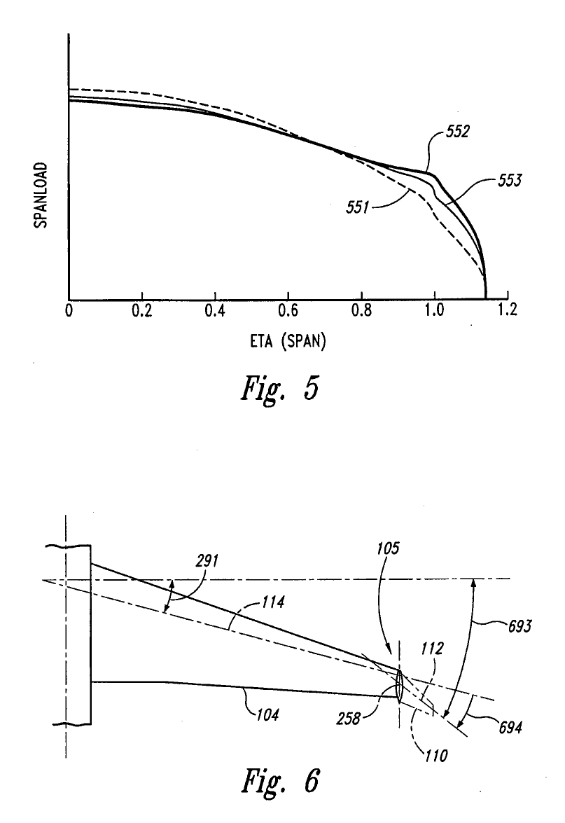

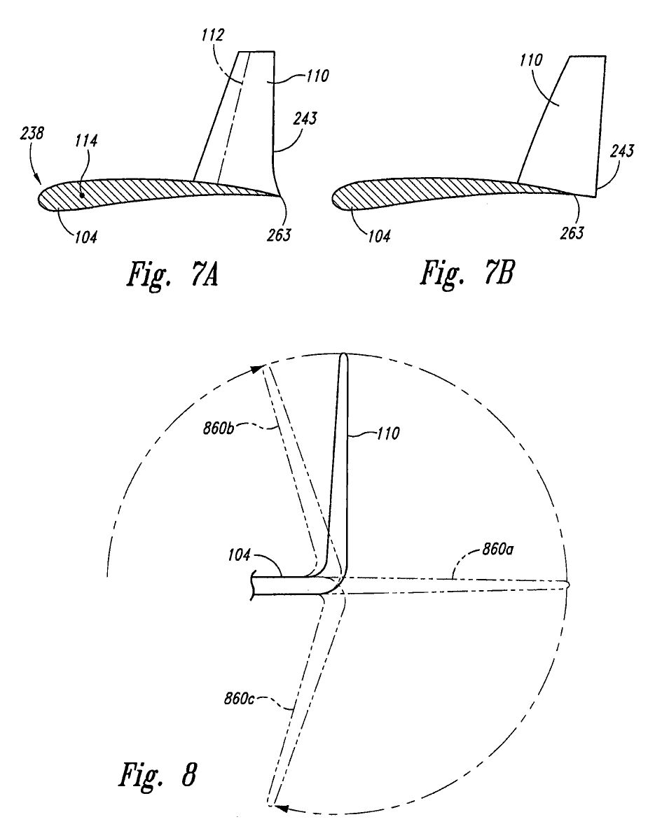

FIG. 5 is a graph illustrating spanload as a function of eta, a non-dimensionalized arc length value along the span of a wing. Curve 551 illustrates the ideal span load for minimum induced drag of a wing having a vertical winglet. Curve 552 illustrates a representative “best” spanload distribution for a wing that has too little washout (e.g., the wing 104 shown in FIG. 3A), with a conventional vertical winglet planform. In this particular embodiment, the conventional winglet planform has a sweep angle that is comparable to the sweep angle of the wing at the wing tip, and has a chord length that is approximately the same as the chord length of the wing at the wing tip. Curve 553 illustrates a representative span load resulting from carrying out the method 480 described above with reference to FIG. 4, e.g., selecting a planform shape of the winglet to produce a reduced loading at the wing tip, compared with the loading produced by the conventional winglet planform and identified by line 552. In a particular aspect of this embodiment, the improved or best available spanload results from sweeping the winglet further aft than the sweep angle of a conventional winglet, and/or shifting the winglet further aft relative to the position of a conventional winglet. Further illustrations of representative winglets having these characteristics are described later with reference to FIGS. 6-8.

The curves shown in FIG. 5 are based on induced drag values. When a wing has too little washout, however, induced drag may not be the only aerodynamic consideration. For example, shock drag and/or viscous drag of the local airfoil sections can increase significantly as a result of the reduced washout. Accordingly, while the designer may use a graph like that shown in FIG. 5 to determine the progress toward reducing or eliminating the additional induced drag resulting from a wing having too little washout, the designer may use a similar graph (or other technique) to determine how the variation in winglet planform shape affects shock drag and/or viscous drag, in addition to or in lieu of assessing induced drag. For example, the designer can develop a composite drag number that includes induced drag, shock drag and viscous drag for determining the level of improvement resulting from different planform shapes, or the designer can identify one or more dominant drag contributors and focus the design efforts on reducing the drag contribution from that/those contributor(s) alone.

FIG. 6 is an unfolded top plan view of the wing/winglet combination 105 of FIG. 2 illustrating the relative sweep angles of the wing quarter-chord line 114 and the winglet quarter-chord line 112 in accordance with an embodiment of the disclosure. For purposes of illustration, the winglet 110 is folded outward and downward in FIG. 3 about the wing tip chord 258 so that it lies in the same plane as the wing 104. This unfolded configuration illustrates that the winglet quarter-chord line 112 is swept aft with respect to the wing quarter-chord line 114, as shown by an aft sweep angle 693, and by an aft relative sweep angle 694. Accordingly, the winglet quarter-chord line 112 is swept further aft than that of a conventional winglet, which is typically swept by the same amount as the wing. In some embodiments (e.g., if the wing 104 has a significant forward sweep), the quarter-chord line of the winglet 112 may actually be swept forward relative to the longitudinal axis 101, but the winglet 110 may still be swept aft relative to the wing quarter-chord line 114.

Once the planform shape of the winglet is established, the designer may use additional techniques to further compensate for the reduced wing tip washout, and/or other causes of high wing tip loading. For example, as shown in FIG. 7A, the winglet 110 can have an aft location relative to the wing tip portion 238 such that the winglet quarter chord line 112 is located aft of the wing quarter chord line 114. In a particular aspect of this embodiment, the winglet trailing edge portion 243 can align with the wing trailing edge portion 263. In another embodiment, shown in FIG. 7B, the winglet trailing edge portion 243 can be offset in an aft direction relative to the wing trailing edge portion 263. The particular location of the winglet 110 relative to the wing tip 238 (in a chord-wise direction) can depend upon the particular geometry of the wing 104 and an evaluation of other parametric variables, e.g., a trade between drag reduction to be achieved by the winglet 110 and a weight increase resulting from the winglet 110.

FIG. 8 is an enlarged rear elevation view of the winglet 110 of FIG. 2 configured in accordance with an embodiment of the disclosure. In one aspect of this embodiment, the winglet 110 extends at least generally upwardly with respect to the wing 104 such that the winglet 110 is at least generally perpendicular to the wing 104. In other embodiments, the winglet 110 can extend at other angles with respect to the wing 104. For example, in one other embodiment, as shown by a first phantom position 860a, the winglet 110 can extend at least generally outwardly from the wing 104 in a horizontal direction, though in this case, the winglet would generally be considered a wing extension. In another embodiment, as illustrated by a second phantom position 860b, the winglet 110 can extend at least generally upward and inward with respect to the wing 104. In a further embodiment, as illustrated by a third phantom position 860c, the winglet 110 can extend at least generally downward and inward with respect to the wing 104. In other embodiments, the winglet 110 can assume a range of different cant angles between the second position 860b and the third position 860c. Such cant angles can depend on a number of factors, including, for example, mitigating transonic shock interaction, reducing structural loads, and/or optimizing the reduction of aerodynamic drag. In general, if the wing 104 is selected for its short span (e.g., so as to more easily fit into airport gate locations), it is expected that upward or downward cant angles will be preferred to the horizontal orientation.

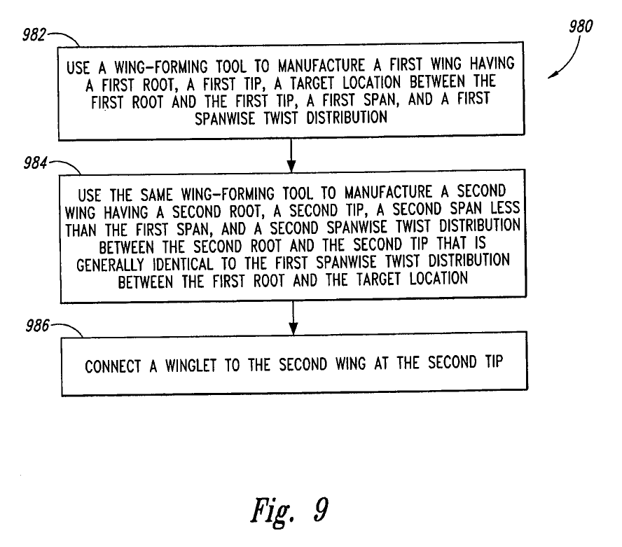

FIG. 9 is a flow diagram illustrating a process 980 for manufacturing wings in a system of wings in accordance with an embodiment of the disclosure. Process portion 982 includes using a wing-forming tool to manufacture a first wing having a first root, a first tip, a target location between the first root and the first tip, a first span, and a first spanwise twist distribution. Process portion 984 includes using the same wing-forming tool to manufacture a second wing. The second wing has a second root, a second tip, a second span less than the first span, and a second spanwise twist distribution. The second spanwise twist distribution, between the second root and the second tip, is generally identical to the first spanwise twist distribution between the first root and the target location. Process portion 986 includes connecting a winglet to the second wing at the second tip.

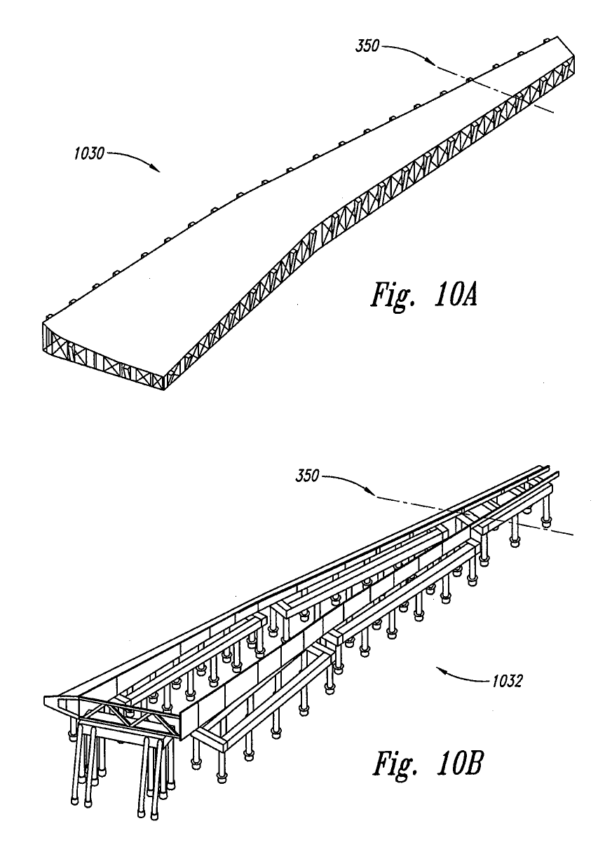

FIGS. 10A and 10B illustrate, in partially schematic format, tools for forming wings in accordance with the process described above with reference to FIG. 9. For example, FIG. 10A illustrates a lay-up tool 1030 that can be used to form both the first wing described above with reference to FIG. 9 (e.g., the baseline wing 104a shown in FIG. 1) and the second wing described above with reference to FIG. 9 (e.g., the wing 104 shown in FIG. 1). In particular, a first wing skin can be laid up using the entire spanwise extent of the lay-up tool 1030. When forming the skin for the second wing, the lay-up surfaces of the tool only up to the target location 350 are used. In a similar manner, the wing box assembly tool 1032 shown in FIG. 10B can have its entire spanwise extent used when forming the first wing, and, when the second wing is formed, only the portion of the wing box assembly tool 1032 extending outwardly to the target location 350 can be used.

One feature of at least some of the foregoing embodiments is that they can include designing and/or manufacturing wings having a reduced span using designs and/or manufacturing processes developed for a baseline wing having a larger span. As a result, the new or modified wing need not be developed from scratch, but can instead take advantage of existing designs and tooling for much of its development. This can result in a significant savings in the cost of developing and manufacturing a new aircraft wing. For example, in a particular instance, it may be desirable to take advantage of an existing wing design when developing a lower capacity aircraft, e.g., an aircraft having a smaller fuselage and/or take-off gross weight (TOGW). In order to meet tight airport gate parking restrictions, it may be desirable to reduce the span of the wing for such an aircraft. Using the foregoing techniques, such a wing can be developed and manufactured without starting from scratch.

As was also discussed above, merely “cutting off” an existing wing design at a less than full-span location may produce a wing having a performance level less than is desired. In particular, this design approach can result in the tip of the wing having less twist than it was designed for. However, by sizing and shaping a winglet in accordance with the foregoing embodiments, the potential decrease in performance can be at least partially (and in some cases, completely) recouped. Accordingly, embodiments of the winglet design process described above can significantly increase the feasibility of using an existing wing design to develop a reduced-span wing.

From the foregoing, it will be appreciated that specific embodiments of the disclosure have been described herein for purposes of illustration, but that various modifications may be made without deviating from the disclosure. For example, the particular wings and winglet geometries shown and described above, and the particular aircraft on which they are installed, may have different configurations in other embodiments. Certain aspects of the disclosure described in the context of particular embodiments may be combined or eliminated in other embodiments. For example, the various cant angles shown in FIG. 8 may be combined with any of the various winglet locations described with reference to FIGS. 7A and 7B. Further, while advantages associated with certain embodiments have been described in the context of those embodiments, other embodiments may also exhibit such advantages, and not all embodiments need necessarily exhibit such advantages to fall within the scope of the invention. Accordingly, the disclosure can include other embodiments not specifically shown or described above.

I/We claim:

1. A method for designing a wing, comprising:
establishing a target lift value for a winglet to be attached to a wing, the wing having wing root, a wing tip and a twist distribution that results in a loading at the wing tip that is higher than a target loading level; and
selecting a planform shape of the winglet to produce less of an increase in loading at the wing tip compared to the wing tip loading produced by other winglet planform shapes having the same target lift value.

2. The method of claim 1 wherein the wing has a twist distribution that results in a washout at the wing tip that is less than a target washout level.

3. The method of claim 1 wherein selecting a planform shape includes selecting a planform shape that produces a minimal loading increase at the wing tip when compared with all other planform shapes having the same target lift value.

4. The method of claim 1 wherein selecting a planform shape includes selecting a sweep angle of the winglet.

5. The method of claim 4 wherein selecting the sweep angle of the winglet includes selecting the sweep angle of the winglet so that a leading edge of the winglet is swept aft relative to a leading edge of the wing at the wing tip.

6. The method of claim 1 wherein selecting a planform shape includes selecting a location of a leading edge of the winglet relative to a location of a leading edge of the wing.

7. The method of claim 6 wherein selecting the location of the winglet leading edge includes selecting the location to be aft of the wing leading edge at the tip of the wing.

8. The method of claim 1 wherein selecting a planform shape includes selecting a location of a trailing edge of the winglet relative to a location of a trailing edge of the wing.

9. The method of claim 8 wherein selecting the location of the trailing edge of the winglet includes selecting the trailing edge location to be aft of the wing trailing edge at the tip of the wing.

10. The method of claim 1 wherein the wing is the second of two wings, and wherein a first wing has a first wingspan, a first twist distribution, a first root, a first tip, and a target location between the first root and the first tip, and wherein the method further comprises selecting the second wing to:
correspond in part to the first wing and to have a second root and a second tip; and
have a second twist distribution between the second root and the second tip that is generally the same as the first twist distribution between the first root and the target location.

11. The method of claim 10 wherein the first wing has a first planform shape and wherein the method further comprises selecting the second wing to have a second planform shape between the second root and the second tip that is generally the same as the first planform shape between the first root and the target location.

12. The method of claim 1 wherein the wing has a twist distribution that results in a washout at the wing tip that is less than a target washout level and wherein selecting a planform shape of the winglet includes selecting the planform shape to account, at least in part, for the washout being less than the target washout level by:
selecting a location of a leading edge of the winglet to be aft of a leading edge of the wing at the tip of the wing;
selecting a sweep angle of the winglet-so that a leading edge of the winglet is swept aft relative to a leading edge of the wing at the wing tip; and
selecting a root chord length of the winglet to be less than a chord length of the wing at the wing tip.

13. An arrangement of wings for aircraft of different sizes, comprising:
a first wing having a first wingspan, a first twist distribution, a first root, a first tip, and a target location between the first root and the first tip; and
a second wing corresponding in part to the first wing and having a second root and a second tip, the second wing further having a second twist distribution between the second root and the second tip that is generally identical to the first twist distribution between the first root and the target location, the second wing further having a winglet at the second tip.

14. The arrangement of claim 13 wherein the first wing has no winglet.

15. The arrangement of claim 13 wherein the winglet is the second of two winglets and wherein the first wing has a first winglet, further wherein a sweep angle of the second winglet relative to the second wing is greater in an aft direction than is a sweep angle of the first winglet relative to the first wing.

16. The arrangement of claim 13 wherein the first wing has a first planform shape and wherein the second wing has a second planform shape between the second root and the second tip that is generally identical to the first planform shape between the first root and the target location.

17. The arrangement of claim 13 wherein the first wing is carried by an aircraft having a first maximum TOGW and the second wing is carried by a second aircraft having a second maximum TOGW less than the first.

18. A method for manufacturing an arrangement of wings, comprising:
using a wing-forming tool to manufacture a first wing having a first root, a first tip, a target location between the first root and the first tip, a first span, and a first spanwise twist distribution;
using the same wing-forming tool to manufacture a second wing having a second root, a second tip, a second span less than the first span, and a second spanwise twist distribution between the second root and the second tip that is generally identical to the first spanwise twist distribution between the first root and the target location; and
connecting a winglet to the second wing at the second tip.

19. The method of claim 18 wherein using a wing-forming tool includes using a first tool for laying up a composite wing structure.

20. The method of claim 19 wherein using the wing-forming tool includes laying up a composite structure over a first spanwise portion of the tool for the first wing, and laying up a composite structure over a second spanwise portion of the tool, less than the first spanwise portion, for the second wing.

21. The method of claim 18 wherein using a wing-forming tool includes using an assembly tool for positioning wing components.

22. The method of claim 18, further comprising forming the first wing to have a first washout at the first tip, and forming the second wing to have a second washout, less than the first washout, at the second tip.

23. The method of claim 18 wherein connecting a winglet includes connecting a winglet having:
a leading edge that is (a) positioned aft of a leading edge of the wing at the tip of the wing and (b) swept aft relative to the leading edge of the wing at the wing tip; and
a root chord length that is less than a chord length of the wing at the wing tip.

24. The method of claim 18 wherein connecting a winglet includes connecting a winglet having a leading edge that is swept aft relative to the leading edge of the wing at the wing tip.

25. The method of claim 18 wherein using the wing-forming tool to manufacture a first wing includes using the wing-forming tool to manufacture a first wing having a first planform shape, and wherein using the same wing-forming tool to manufacture a second wing includes using the same wing-forming tool to manufacture a second wing having a second planform shape that is generally identical to the first planform shape inboard of the target location.
